(19) United States
(12) Patent Application Publication
(10) Pub. No.: US 2022/0039451 A1
(43) Pub. Date: Feb. 10, 2022

(54) COMPOSITION FOR THE PREPARATION OF FOOD PRODUCTS FOR SUBJECTS WITH SWALLOWING DIFFICULTY

(71) Applicant: HEALTHY AGING RESEARCH GROUP SOCIETÀ BENEFIT S.R.L. IN SIGLA H.A.R.G. S.R.L, Brescia (IT)

(72) Inventors: Milko ZANINI, Genova (IT); Loredana SASSO, Bordighera Imperia (IT); Annamaria BAGNASCO, Genova (IT); Gianluca CATANIA, Genova (IT); Giancarlo ICARDI, Genova (IT); Matteo OPPI, Piadena (CR) (IT); Antonio Rosario ROMANO, Piadena (CR) (IT); Stefania RIPAMONTI, Brugherio (MB) (IT)

(21) Appl. No.: 17/296,374

(22) PCT Filed: Nov. 26, 2019
(86) PCT No.: PCT/IB2019/060158

§ 371 Date: May 24, 2021

(30) Foreign Application Priority Data
Nov. 29, 2018 (IT) 102018000010674

(51) Int. Cl. A23L 33/00; A23L 7/10; A23L 29/238; A23L 33/19

(52) U.S. Cl. CPC A23L 33/40; A23L 33/19; A23L 29/238; A23L 7/198

(57) ABSTRACT

Subject-matter of the present invention is a composition suitable for the preparation of food products essentially intended for subjects with swallowing difficulty and/or malnourished subjects. Further subject-matter of the invention is a process for the preparation of such food products and the so-prepared food products.

### TECHNICAL FIELD

Protein-energy malnutrition (PEM) is an energy deficit due to a lack of macronutrients, being a condition of particular relevance both for the magnitude of the phenomenon and for the related clinical and welfare implications.

In developed countries, the protein-energy malnutrition is common among elderly people, in particular in hospitalized elderly people, and among patients with diseases reducing appetite or compromising digestion, absorbance or metabolism of nutrients.

The subjects with swallowing disorders, in particular the subjects suffering from swallowing deficit, are particularly at risk of malnutrition. The swallowing deficit is a dysfunction related to swallowing affecting many subjects; the subject suffering from swallowing deficit can not properly swallow food and beverages. The term “swallowing deficit” includes a plurality of dysfunctions among which dysphagia.

In particular, the presence of multiple textures in the food of subjects suffering from swallowing deficit can involve several risks, e.g. the risk of suffocation and the risk of pneumonia ab-ingestis, deriving from the food particles inhaled in the respiratory system, e.g. following the incomplete occlusion of trachea during swallowing.

Various kinds of foods which can be administered to subjects suffering from swallowing deficit are known. Such food can have different textures and be optionally flavored.

Examples of such foods are the extemporaneous preparations, based on blending or homogenizing food already prepared according to traditional methods, by mixing them with diluents, such as water or broth, and with thickeners in order to obtain the desired texture, density and viscosity. However, the caloric intake and the nutritional value of the known extemporaneous preparations result to be very low.

Industrial preparations in the form of semifinished products or “ready meals” which can be converted into suitable food for subjects with swallowing deficit by means of thermal treatment, reconstitution from freeze-dried product, or ready-to-use are known.

However, also the industrial preparations present disadvantages.

For example, the known industrial preparations have high manufacturing costs, a general poor palatability and a modest nutritional supply.

Therefore it is difficult, by using the known preparations, to be able to provide a proper nutrition to the food consumer. For example, it is possible to obtain a satiating effect by providing high volume to scarce amounts of the preparation, obtaining satiety in those taking the food, but providing an insufficient supply of nutritive substances. Pharmaceutical food supplements are also known, allowing to obtain acceptable nutritional amounts, but resulting to be poorly palatable.

There is therefore the need of providing compositions for the preparation of food products suitable to be administered to subjects suffering from swallowing difficulty.

### OBJECTS OF THE INVENTION

Object of the present invention is to provide a composition suitable for the preparation of food products essentially, but without limitation, addressed to subjects suffering from swallowing difficulty, which allow to provide sufficient supply of nutritional substances to such subjects.

Another object of the present invention is to provide a composition suitable for the preparation of food products essentially, but without limitation, addressed to subjects suffering from swallowing difficulty, which have a pleasant taste.

It is a further object of the invention to provide a process for the preparation of a food product suitable for subjects suffering from swallowing difficulty, preferably said process being carried out in an automated mode.

Another object of the present invention is to provide a food product having high nutritional value and which is at the same time pleasant to the palate.

### DESCRIPTION OF THE INVENTION

Subject-matter of the invention, according to one of the aspects thereof, is the use of a powdered food composition comprising at least one natural gum, whey and at least one flour of at least one grain, wherein the reciprocal weight ratio of at least one natural gum/whey/at least one flour of at least one grain is 1/1-5/1.5-7, for the preparation of a product for the nutrition of subjects with swallowing difficulty and/or malnourished subjects.

According to an embodiment, said reciprocal weight ratio is 1/1.5-4/2-6.

With “powdered food composition” it is herein meant a powdered solid composition to be reconstituted by dilution with a suitable liquid, to provide a product suitable for human and animal nutrition. The composition of the invention can be in the freeze-dried, not freeze-dried or partially freeze-dried form, where with “partially freeze-dried” it is meant that at least one of the components in said composition is freeze-dried.

According to the present invention, with “whey” it is herein meant powdered whey, i.e. the product obtained from the dehydration of the fluid remaining from the animal milk after the production process of cheese. Said powdered whey is well known to the skilled in the art and is commercially available.

According to the present invention, with “natural gum” it is herein meant any gum for food use having thickening properties, selected from e.g. guar gum, acacia gum (or arabic gum), xanthan gum, karaya gum, tara gum, gellan gum and mixtures thereof. According to a preferred embodiment, said at least one natural gum is guar gum.

According to the present invention, with “at least one flour of at least one grain” it is meant flour or a flour mixture obtained from grains. The term “grain” it is herein not limited to the plants of the Gramineae family, such as durum wheat, soft wheat, kamut, rye, barley, spelt, rice, corn, millet, sorghum and oat but includes herein also other vegetables considered pseudo-grains, i.e. plants which, even not belonging to the Gramineae family, provide flours usable for food use, such as buckwheat, quinoa, amaranth and chia.

According to a preferred embodiment, said at least one flour of at least one grain is rice flour.

According to a preferred embodiment, at least another food component is present in the composition of the invention and, with respect to the total weight of the composition, the components defined above are present in said composition in the following amounts:
said at least one natural gum, preferably guar gum, is present in the range from 4% to 12%, preferably 5-10% by weight;
said whey is present in the range from 5% to 25%, preferably 5-10% by weight; and
said at least one flour of at least one grain, preferably the rice flour, is present in the range from 6% to 35%, preferably 8-30% by weight.

As stated, the composition of the invention can preferably comprise also at least one component, preferably at least two components, more preferably at least three other components, preferably selected among: yeast extract, coconut oil, potato powder or flakes, sodium caseinate, carboxymethyl cellulose (C.M.C), chicken proteins, carob flour, powdered skimmed milk and powdered cream.

According to a particularly preferred embodiment, the composition of the invention comprises yeast extract, advantageously in an amount between 1 and 5%, preferably about 2-3% by weight, with respect to the total weight of the composition. Said yeast extract is preferably present in the compositions of the invention having a salty taste, since it strengthen the taste and imparts a good sapidity and allows to avoid, or at least to limit, the addition of flavorings such as glutamate.

According to a preferred embodiment, the composition of the invention further comprises at least one flavor and/or one extract for food use, preferably flavors and/or extracts of natural origin. By way of example, with “natural origin flavors” and “natural origin extracts” it is herein meant one or more edible flavoring substances, obtained from vegetables or animals, imparting to the food product obtained with the composition of the invention peculiar tastes, smells and fragrances. Alternatively, the composition of the invention can comprise at least one flavor and/or one extract for food use not of natural origin, i.e. chemically synthesized.

In some embodiments, the composition of the present invention can include salt and/or flavorings and/or sugar or other natural or artificial sweeteners, preferably natural. Subject-matter of the invention, according to another of the aspects thereof, is a process for the preparation of a food product comprising a step of mixing at least one composition, as defined above, with an aqueous liquid for food use, said aqueous liquid being added in a suitable amount in order to provide a food product having density such that it falls within grade 3 or 4 of the IDDSI scale.

The IDDSI scale is known in the art. The term “IDDSI” means the “International Dysfagia Diet Standardisation Initiative” and has been created in 2013 with the aim of developing, at international level, a new standardized terminology and defining the descriptions of “texture” of modified foods and thickened liquids used for the people suffering from the swallowing deficit. Details of such standardized scale are provided in the Experimental Section of the present description.

According to a preferred embodiment, in order to obtain a food product having density such that it falls within grade 3 or 4 of the IDDSI scale, therefore a product suitable for the nutrition of subjects suffering from the swallowing deficit, commonly amounts between 14 and 25 g, preferably between 14 and 20, of the composition of the invention are mixed in 100 ml of aqueous liquid, said aqueous liquid being preferably water, advantageously hot water.

By way of example, in order to obtain a product of grade 4 of the IDDSI scale, from about 20 to about 16.5 g of composition can be mixed with 100 ml of aqueous liquid, while in order to obtain a product of grade 3 of the IDDSI scale, from about 16.5 g to about 14.5 g of composition can be mixed with 100 ml aqueous liquid, advantageously water, preferably hot water. The person skilled in the art, based on the indications provided by the IDDSI standard described above and on the kind of composition according to the invention, is completely capable of evaluating the amount of composition to be mixed with the aqueous liquid in order to obtain a food product that falls within grade 3 or 4 of said IDDSI scale, according to the requirements of the subject to whom the product will be administered.

Advantageously, the process according to the present invention can be carried out in an automated way by using dispensing devices and/or machines. Such devices are per se known to the person skilled in the art and, advantageously, allow to prepare a high number of portions of the food product according to the present invention in a rapid and standardized way. In other words, the preparation of a food product according to the present invention by means of the use of dispensing devices and/or machines allows the preparation of several food portions, which have essentially the same texture and nutritional properties.

The process of the invention using dispensing devices and/or machines is a further subject-matter of the invention.

According to one of its aspects, another subject-matter of the invention, is the use of the compositions as defined in the present description, in dispensing devices and/or machines. In particular, subject-matter of the invention is the use of the composition of the invention for the preparation of the food product of the invention by means of dispensing devices and/or machines.

A further advantageous aspect of the present invention, is represented by the fact that the product obtained by reconstitution with water, preferably hot water, starting from the powder composition, is extremely stable. Even after a hours from the extemporaneous preparation, carried out manually or through a dispensing/vending machine, no phase separation in the finished product can be observed. Moreover, even if the finished food preparation is left in contact with air or cooled in a blast chiller and then reconstituted by heating, it does not show the formation of a film on the surface that could lead to creation of double consistencies.

Advantageously, in some embodiments, preferably in the embodiments wherein the food product is obtained starting from a composition comprising salted components, one or more fat components, e.g. oil, can be added to any portion of finished food product. For example, when the portion of the food product according to the invention is in an amount ranging from 150 and 175 g, about 10 g of oil can be added. Advantageously, such addition allows to give to the food product a suitable energy value and allows to supplement the food product with a fat amount, generally of difficult incorporation into the powdered composition.

It has been possible to observe that the fat amount (preferably oil) is easily worked in the food products according to the invention, the latter remaining homogeneous and keeping a well defined density according to the standards defined by the IDSSI scale, described above.

The food product obtainable and/or obtained by means of the process described herein represents a further subject-matter of the invention.

Surprisingly and unexpectedly, it has been observed that the three components defined above, in the defined reciprocal weight ratios and more preferably in mixture with at least another food component and in the percentage amounts set forth above, are a food powder which, once suitably reconstituted according to the process described above, provides a food product suitable for human and animal nutrition, in particular but without limitation, suitable for the nutrition of particular categories of subjects, such as the subjects having swallowing deficit and/or malnourished. As a matter of fact, thanks to the high protein supply and, when suitably reconstituted to its peculiar texture, the food product of the invention is well suited for the nutrition of such subjects.

However it is clear that, in addition to the subjects set forth above, the composition and the food product of the invention can be used in the nutrition of a wide range of subjects, e.g. children, convalescent subjects and the like.

Subject-matter of the invention, according to another of the aspects thereof, is the use of the composition as described and claimed herein for the preparation of a product for the nutrition of subjects with swallowing difficulty and/or malnourished.

Subject-matter of the invention, according to another of the aspects thereof, is the use of at least one food product as described and claimed herein, for the nutrition of subjects with swallowing difficulty and/or malnourished.

Subject-matter of the invention, according to another of the aspects thereof, is a method for the nutrition of a subject with swallowing difficulty and/or malnourished, comprising administering to said subject at least one food product as described and claimed herein, preferably in an effective and/or adequate amount of said food product. In the present description, with “subject” it is meant a human or animal subject, preferably a mammal, more preferably the human being.

The invention will be described in more detail in the following Experimental Section, by way of example only and without limitation.

### EXPERIMENTAL SECTION

### Example 1

Food compositions according to the present invention have been prepared by mixing the different powdered components.

Composition 1—Spinach Flavor

| INGREDIENTS | % |
|---|---|
| Rice Flour | 28 |
| Powdered Coconut Oil | 3 |
| Powdered Spinach | 7 |
| Micronized Potato Flakes | 9.5 |
| Sodium Caseinate (92%)* | 24 |
| Whey (12%)* | 18 |
| Guar Seed Flour E412 | 6 |
| C.M.C. | 1.5 |
| Yeast Extract | 2 |
| Salt | 1 |
| | 100 |

*The percentage in parentheses indicates the amount of proteins present in the raw material, expressed as weight percentage with respect to the weight of the raw material used.

The protein content of Composition 1 was 28.80 g/100 g.

Such protein content has been determined according to the ISO 1871:2009 standard.

Composition 2—Pumpkin and Rosemary Flavor

| INGREDIENTS | % |
|---|---|
| Rice Flour | 28 |
| Powdered Coconut Oil | 3 |
| Powdered Pumpkin | 7 |
| Powdered Rosemary | 1.5 |
| Sodium Caseinate (92%)* | 24 |
| Whey (12%)* | 14 |
| Guar Seed Flour E412 | 10 |
| Curcuma Mix Y016 | 8 |
| Yeast Extract | 2 |
| C.M.C. | 1.5 |
| Salt | 1 |
| | 100 |

*The percentage in parentheses indicates the amount of proteins present in the raw material, expressed as weight percentage with respect to the weight of the raw material used.

The protein content of Composition 2 was 25.90 g/100 g.

Such protein content has been determined according to the ISO 1871:2009 standard.

Composition 3—Pizzaiola Flavor

| INGREDIENTS | % |
|---|---|
| Rice Flour | 28 |
| Powdered Coconut Oil | 3 |
| Powdered Tomato | 12 |
| Natural Extract of Fermented | 0.2 |
| Red Rice | |
| Sodium Caseinate (92%)* | 24 |
| Whey (12%)* | 17.8 |
| Guar Seed Flour E412 | 10 |
| Powdered Oregano | 2 |
| Yeast Extract | 2 |
| Salt | 1 |
| | 100 |

*The percentage in parentheses indicates the amount of proteins present in the raw material, expressed as weight percentage with respect to the weight of the raw material used.

The protein content of Composition 3 was 26.90 g/100 g.

Such protein content has been determined according to the ISO 1871:2009 standard.

Composition 4—Pork Ribs Flavor

| INGREDIENTS | % |
|---|---|
| Rice Flour | 28 |
| Pork Proteins (Scanpork D85) | 30 |
| Whey (12%)* | 17.5 |
| Guar Seed Flour E412 | 10 |
| C.M.C. | 1.5 |
| Rib Eye Steak Natural Flavor | 1 |
| 7.19002 | |
| Beef Meat Flavor 37007 | 9 |
| Yeast Extract | 3 |
| | 100 |

*The percentage in parentheses indicates the amount of proteins present in the raw material, expressed as weight percentage with respect to the weight of the raw material used.

The protein content of Composition 4 was 33.50 g/100 g.

Such protein content has been determined according to the ISO 1871:2009 standard.

Composition 5—Pork base Flavor

| INGREDIENTS | % |
|---|---|
| Rice Flour | 28 |
| Guar Seed Flour | 5 |
| Potato Flake | 5 |
| Powdered Whey | 18.7 |
| Powdered Beet | 0.6 |
| Pork Proteins (Scanpork D85) | 30 |
| Characterizing Natural Flavor | 11 |
| C.M.C. | 1.7 |
| | 100 |

The protein content of Composition 5 was 32.30 g/100 g.

Such protein content has been determined according to the ISO 1871:2009 standard.

The “Characterizing Natural Flavor” component can be selected in order to obtain different variations of Composition 5 flavor. For example, by properly selecting the “Characterizing Natural Flavor” component, it will be possible to obtain compositions with ham, roasted loin or lemon loin flavor. Characterizing natural aromas adapted to be used in the compositions according to the present invention are known to the skilled in the art.

Composition 6—Chicken Based Flavor

| INGREDIENTS | % |
|---|---|
| Rice Flour | 28 |
| Guar Seed Flour E412 | 10 |
| Whey (12%)* | 18.5 |
| Chicken Protein C30 | 30 |
| Yeast Extract | 2 |
| Characterizing Natural Flavor | 10 |
| C.M.C. | 1.5 |
| | 100 |

*The percentage in parentheses indicates the amount of proteins present in the raw material, expressed as weight percentage with respect to the weight of the raw material used.

The protein content of Composition 6 was 31.7 g/100 g.

Such protein content has been determined according to the ISO 1871:2009 standard. The “Characterizing Natural Flavor” component can be selected in order to obtain different variations of Composition 6 flavor. For example, by properly selecting the “Characterizing Natural Flavor” component, it will be possible to obtain compositions with roasted chicken, lemon chicken or grilled chicken flavor. Characterizing natural aromas adapted to be used in the compositions according to the present invention are known to the skilled in the art.

Composition 7—Pepper and Olive Puree Flavor

| INGREDIENTS | % |
|---|---|
| Rice Flour | 28 |
| Powdered Coconut Oil | 3 |
| Powdered Red Pepper | 7 |
| Micronized Potato Flakes | 10 |
| Sodium Caseinate (92%)* | 24 |
| Whey (12%)* | 8.3 |
| Guar Seed Flour E412 | 6 |
| C.M.C. | 1.7 |
| Yeast Extract | 2 |
| Curcuma Mix Y016 | 2 |
| Powdered Black Olives | 1.5 |
| Sweet Napoli Natural Flavor S045 | 5.5 |
| Salt | 1 |
| | 100 |

*The percentage in parentheses indicates the amount of proteins present in the raw material, expressed as weight percentage with respect to the weight of the raw material used.

The protein content of Composition 7 was 26.3 g/100 g.

Such protein content has been determined according to the ISO 1871:2009 standard.

Composition 8—Sachertorte Flavor

| INGREDIENTS | % |
|---|---|
| Rice Flour | 8 |
| Guar Seed Flour | 5 |
| Carob Flour | 6 |
| Powdered Skimmed Milk | 32 |
| Powdered Cream | 4 |
| Powdered Coconut Oil | 5 |
| Sodium Caseinate | 16 |
| Powdered Whey | 5.5 |
| Powdered Cocoa | 15 |
| Pure Extract of Stevia | 0.2 |
| Characterizing Natural Flavor | 0.3 |
| C.M.C. | 3 |
| | 100 |

Characterizing natural aromas adapted to be used in the compositions according to the present invention are known to the skilled in the art. The protein content of Composition 8 was 28.80 g/100 g.

Such protein content has been determined according to the ISO 1871:2009 standard.

### Example 2

By way of example, Composition 3 (“Pizzaiola Flavor”), described above, has been used to prepare a food product according to the present invention.

25 g of powdered Composition 3 have been mixed with 125 ml of water at the temperature of about 90° C.

The mixture is stirred until obtaining a mixture free from lumps and with a homogeneous texture.

By mixing 25 g of composition with 125 ml, a food product falling within grade 4 of IDDSI (International Dysphagia Diet Standardisation Initiative) scale is obtained. The grade of the IDDSI scale can be determined by known methods, in particular by means of the methods described in the publication “IDDSI Framework—testing methods”, currently available at the URL http://iddsi.org/Documents/IDDSIFramework-TestingMethods.pdf

For example, as it is known, the IDDSI grade of a food product according to the present invention can be determined by means of a flux test, by using a 10 ml syringe into which 10 ml of the food are inserted. The food is left to flow from the tip hole of the syringe for 10 seconds. After 10 second of flow, the leakage of the food from the syringe is stopped and the amount of residual food in the syringe is measured. For example, the IDDSI flux test can be carried out by using a hypodermic syringe “Luer slip” of 10 ml.

Preferably, the IDDSI flux test can be carried out by using a syringe with a length, comprised between the line corresponding to 0 ml and the line corresponding to 10 ml, equal to 61.5 mm (e.g., the BDTM test syringes—manufacturer code 301604). As it is known to the person skilled in the art, it is important to verify that the food volume placed inside the syringe is actually the predefined volume for the execution of the measurement.

As previously discussed, the IDDSI grade of a food product according to the present invention can be determined based on the amount of residual food inside the syringe after 10 seconds of flow.

In particular, a residue of 8 ml or more (e.g. in presence of minimal amounts of food leaking from the syringe), corresponds to a food according to the present invention of grade 3 of the IDDSI scale.

A food according to the present invention falls within grade 4 of the IDDSI scale when essentially no leaking of the food from the syringe occurs.

In other words, a food according to the present invention falls within grade 4 of the IDDSI scale when, at the end of 10 seconds, the amount of food according to the invention inside the syringe is essentially equal to the initial food amount. Grade 4 of the IDDSI scale can be also identified by tests different from the syringe test, known per se. Differently from grade 3 foods of the IDDSI scale, grade 4 foods, for example, keep its own form, are of a too dense texture to be drunk and require the use of a spoon.

1-19. (canceled)

20. A method for feeding subjects with swallowing difficulty and/or malnourished subjects which comprises administering to said subjects a powdered food composition comprising at least one natural gum, whey and at least one flour of at least one grain wherein the reciprocal weight ratio of at least one natural gum/whey/at least one flour of at least one grain is 1/1-5/1.5-7.

21. The method according to claim 20, wherein said reciprocal weight ratio is 1/1.5-4/2-6.

22. The method according to claim 20, wherein said at least one natural gum is guar gum.

23. The method according to claim 20, wherein said at least one flour of at least one grain is rice flour.

24. The method according to claim 20, wherein the amount of said at least one natural gum is in the range from 4% to 12% by weight, the amount of said whey is in the range from 5% to 25% by weight and the amount of said at least one flour of at least one grain is in the range from 6% to 35%, by weight with respect to the total weight of the composition.

25. The method according to claim 20, further comprising at least one component, selected from: yeast extract, coconut oil, potato flakes, sodium caseinate, carboxymethyl cellulose (C.M.C), chicken proteins, carob flour, powdered skimmed milk and powdered cream.

26. The method according to claim 20, further comprising at least one flavor and/or one extract for food use.

27. A process for the preparation of a food product, comprising a mixing step of at least one composition according to claim 20 with an aqueous liquid, wherein the weight amount of said composition ranges from 14 to 25 g/100 ml of said aqueous liquid.

28. The process according to claim 27, wherein said aqueous liquid is water.

29. The process according to claim 27, wherein said process is carried out in dispensing devices and/or machines.

30. A food product obtained with a process comprising
mixing with an aqueous liquid at least one powdered food composition comprising at least one natural gum, whey and at least one flour of at least one grain wherein the reciprocal weight ratio of at least one natural gum/whey/at least one flour of at least one grain is 1/1-5/1.5-7, wherein the weight amount of said composition ranges from 14 to 25 g/100 ml of said aqueous liquid, wherein said food product have a density falling within level 3 or 4 of the IDDSI scale.

31. A powdered food composition comprising at least one natural gum, whey and at least one flour of at least one grain, wherein:
said at least one natural gum is in the range from 4% to 12% by weight;
said whey is in the range from 5% to 25% by weight; and
said at least one flour of at least one grain is in the range from 6% to 35% by weight.

32. The powdered food composition according to claim 31, wherein said at least one natural gum is guar gum.

33. The powdered food composition according to claim 31, wherein said at least one flour of at least one grain is rice flour.

34. The powdered food composition according to claim 31, further comprising at least two other components selected from: yeast extract, coconut oil, potato flakes, sodium caseinate, carboxymethyl cellulose (C.M.C), chicken proteins, carob flour, powdered skimmed milk and powdered cream.

35. The method according to claim 20, comprising mixing said powdered food composition with an aqueous liquid before the administration to said subjects.

36. The method of claim 35, wherein said mixing is performed in dispensing machines.

37. The method according claim 35, wherein said aqueous liquid is water.

38. The method according claim 37, wherein said aqueous liquid is hot water
